(19) United States
(12) Patent Application Publication
(10) Pub. No.: US 2004/0227413 A1
(43) Pub. Date: Nov. 18, 2004

(54) Electric motor for a linear drive system

(76) Inventors: Oswald Kuwert, Herbolzheim (DE); Axel Boettger, Dresden (DE)

Correspondence Address: DUANE MORRIS LLP, Suite 700, 1667 K. Street, N.W., Washington, DC, 20006, US

(21) Appl. No.: 10/813,172

(22) Filed: Mar. 31, 2004

(30) Foreign Application Priority Data
May 15, 2003 (DE) 103 21 966.8

(51) Int. Cl. H02K 1/04; H02K 7/00; H02K 11/00; H02K 41/00

(52) U.S. Cl. 310/12; 310/43

(57) ABSTRACT

The invention relates to an electric motor for a linear drive system comprising a motor housing within which a stator, a rotor and a threaded shank are accommodated. The stator has a stator core and phase windings which are connected to phase connectors. The rotor is mounted onto a rotor hub, the rotor hub being supported in the motor housing by roller bearings and coupled to the threaded shank via a thread in order to transform the rotation of the rotor into a translational motion of the threaded shaft. In accordance with a first aspect of the invention, the motor housing has an injection molded part within which the stator, together with the stator core and phase windings, is embedded. A linear guide to accommodate and guide the threaded shank is integrated into the injection molded part of the motor housing. In accordance with a second aspect of the invention, the rotor hub is also formed from an injection molded part within which the rotor is fixed, the injection molded part of the rotor hub having an inner thread which interacts with the outer thread of the threaded shank.

### FIELD OF THE INVENTION

The invention relates to an electric motor for a linear drive system. The motor has a motor housing in which a stator, a rotor and a threaded shank are accommodated. The stator includes a stator core and phase windings which are connected to phase connectors. The rotor is mounted onto a rotor hub. The rotor hub is supported in the motor housing by roller bearings and coupled to the threaded shank via a thread in order to transform the rotation of the rotor into a translational motion of the threaded shaft.

Such electric motors are used, for example, in linear actuators in automobile technology. Purely by way of example, we can cite actuators for the idle control of a carburetor valve or also for setting the angle of reflected beam of a dipped beam headlight. It is clearly understood that the invention is not restricted to one specific application.

### BACKGROUND OF THE INVENTION

In the prior art, stepping motors such as claw pole stepping motors and hybrid stepping motors are used for such linear actuators.

In FIG. 1, a partially sectioned perspective view of an example claw pole stepping motor is shown; FIGS. 2a and 2b show an example hybrid stepping motor in a sectional view and a partially sectioned perspective view respectively.

FIG. 1 shows an example of a conventional claw pole stepping motor, including a first stator system 10 and a second stator system 12 as well as a permanent magnet rotor 14 which are coupled via claw poles 16, 18.

The hybrid stepping motor illustrated in FIG. 2a and 2b combines elements of a variable reluctance motor (VR motor) with elements of a permanent magnet motor (PM motor). The hybrid motor illustrated in FIGS. 2a and 2b include a shaft 20 onto which a rotor 22 is mounted. The rotor 22 includes a south pole sprocket, or pole plate 24, and a north pole sprocket, or pole plate 26, between which a permanent magnet 28 is disposed. The two pole plates 24, 26 and the permanent magnet 28 are connected to the shaft 20 via a back iron yoke 30. The rotor 22 is rotatably supported within a stator 32 by means of roller bearings (not illustrated). The stator 32 includes a stator back yoke 34 connected to stator poles 36 which carry stator windings 38.

Hybrid motors have the advantage over conventional claw pole stepping motors in that they have good dampening and generate self-holding torque. Their operating performance is more favorable than claw pole stepping motors in respect of the start-up frequency range and speed and they achieve higher performance for the same or even less volume and size.

It is basically known to encapsulate stators in plastics to improve the reliability of stepping motors. This goes to improve the robustness and vibration-resistance of motors and to provide the motor with thermal insulation. A suitable material used to encapsulate stators for stepping motors is supplied, for example, by Dupont de Nemon under the RYNITE® PET brand name. Another molding material to encapsulate the stator of an electric motor is revealed in EP 0 807 644 B1. The molding material described here is composed in such a way that it enables the motor to be recycled. Other electric motors with a cast or encapsulated stator are revealed in U.S. Pat. No. 6,020,661 and DE-A-101 33 966.

The object of the invention is to submit an electric motor for a linear drive system which can be produced at low cost and with less complex materials and manufacturing process.

### SUMMARY OF THE INVENTION

This object has been achieved through an electric motor having the characteristics outlined in patent claim 1 or patent claim 6.

The invention relates to an electric motor for a linear drive system, having a motor housing in which a stator, a rotor and a threaded shank are accommodated. The stator has a stator core and phase windings which are connected to phase connectors. The rotor is mounted onto a rotor hub. The rotor hub is supported in the motor housing by roller bearings and coupled to the threaded shank via a thread in order to transform the rotation of the rotor into a translational motion of the threaded shaft. In accordance with a first aspect of the invention, the motor housing has an injection molded part within which the stator, together with the stator core and phase windings, is embedded, a linear guide to accommodate and guide the threaded shank being integrated into the motor housing. In accordance with a second aspect of the invention, the rotor hub is also formed from an injection molded part within which the rotor is fixed, the rotor hub having an inner thread which interacts with the outer thread of the. threaded shank.

According to the invention, at least the motor housing or the rotor hub, or preferably both, are thus formed as injection molded parts within which the important functional components of the electric motor, namely the stator and the rotor, are embedded. Moreover, functionally important elements of the linear drive, namely a linear guide for the threaded shank and an inner thread which interacts with the outer thread of the threaded shank, are also integrated in these injection molded parts.

Using the method of construction described above, it is possible to make an electric motor for a linear drive system with minimum cost and complexity in terms of material and manufacture. The elements important for the functioning of the linear drive, namely the linear guide for the actuator rod (threaded shank) and the associated thread, are integrated directly into the said injection molded parts, as are the parts important for the functioning of the electric motor itself, namely the stator and rotor. These are precisely positioned and fixed by the injection molded parts so that no extra components for the assembly, positioning and support of the stator and the rotor are required. In addition, the method of construction presented in the invention enables the stator and the rotor to be positioned with a high degree of precision in respect of each other and a precise air gap, having minimum tolerances, to be set between these two. A further beneficial effect of completely encapsulating the stator in the electric motor according to the invention is that the stator is sealed and protected against environmental influences and, in particular, against the penetration of liquids.

The design presented in the invention enables an astonishing and significant improvement in the precision of the described electric motor, and in particular of a hybrid stepping motor as shown in FIGS. 2a and 2b, in respect of the air gap, as a result of which concentricity errors can be minimized. The manufacture of the motor is simplified with costs being greatly reduced at the same time. Trials have shown that this increase in precision can result in an improvement in performance of about 10% compared to hybrid stepping motors of a conventional design. The construction of the rotor hub according to the invention, within which the thread is directly injection molded, can additionally enable the thickness of the wall between the rotor and the threaded shank to be reduced, as a result of which the usable magnet surface of the rotor and thus the performance which depends on the volume of the rotor, can in return be increased without increasing the overall size of the motor.

In a preferred embodiment of the invention, a stop is additionally integrated into the injection molded part of the motor housing for the purpose of positioning the threaded shank. The stop interacts with the linear guide and restricts the movement of the threaded shank.

A particularly compact and suitable design is produced if the bearing supports for the roller bearings to mount the rotor are also integrated in the motor housing and if a motor flange is directly molded onto the injection molded part of the motor housing. Corresponding bearing supports for the roller bearings are also preferably integrated into the rotor hub.

The electric motor of the invention is preferably formed as a hybrid stepping motor with the rotor having two pole plates which are separated by a magnet plate. The pole plates and the magnet plate are preferably held and positioned in the rotor hub.

### SHORT DESCRIPTION OF DRAWINGS

The invention is described in more detail below on the basis of a preferred embodiment with reference to the drawings. The figures show:

FIG. 1 a schematic, partially sectioned perspective view of a claw pole stepping motor according to the prior art;

FIG. 2a a schematic longitudinal view of a hybrid stepping motor according to the prior art;

FIG. 2b a schematic, partially sectioned perspective view of the hybrid stepping motor shown in FIG. 2a;

FIG. 3 a schematic sectional view through an electric motor for a linear drive system according to the invention.

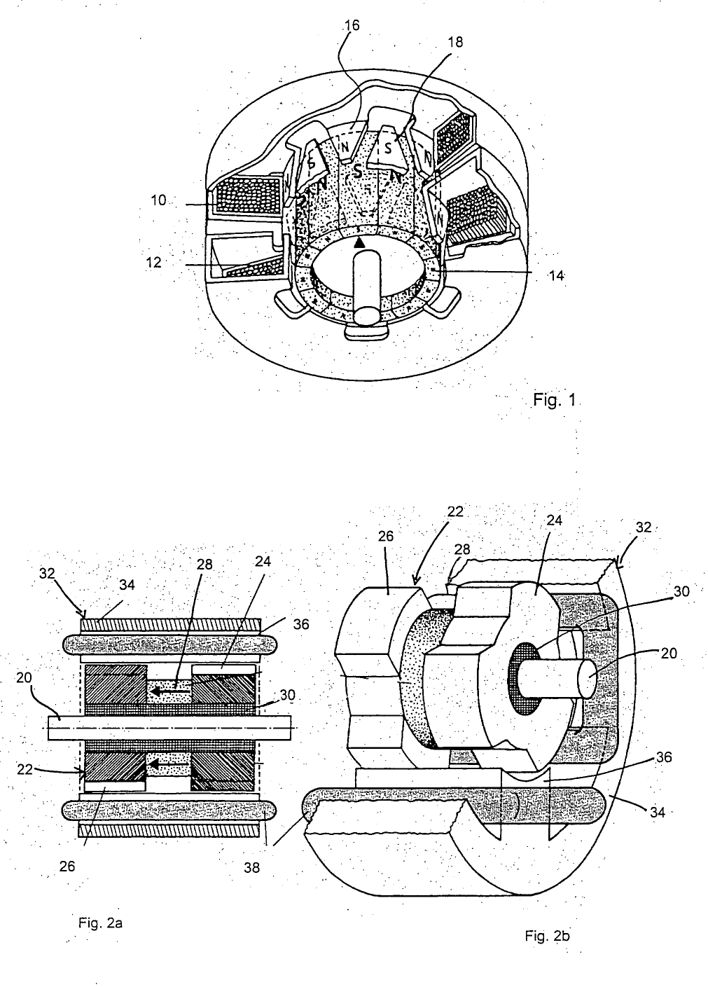

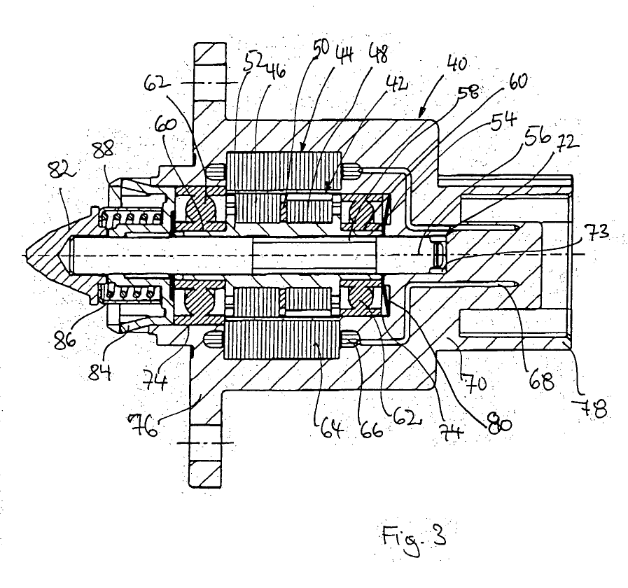

### DETAILED DESCRIPTION OF PREFERRED EMBODIMENTS

FIG. 3 shows an electric motor for a linear drive system according to a preferred embodiment of the invention. The electric motor illustrated in FIG. 3 is a hybrid stepping motor. Although the invention can also be applied to other electric motors, it is preferably used in connection with such hybrid stepping motors.

The electric motor in general is identified by 40 in FIG. 3. It includes a rotor 42 and a stator 44. The rotor 42 has a first pole plate 46 e.g. a south pole sprocket, and a second pole plate 48, e.g. a north pole sprocket, which are separated by a permanent magnet 50. The rotor 42 is positioned and fixed on a rotor hub 52.

According to the invention, the rotor hub 52 is formed as an injection molded part within which the rotor 42 is fixed. The rotor 42 can be partly molded onto the rotor hub 52 or pressed or bonded onto it. Other means of connecting the rotor 42 and the rotor hub 52 are also conceivable.

The rotor hub 52 has a through hole 54 in which an inner thread is formed (not illustrated in FIG. 3) being preferably made in the one and the same manufacturing process as the injection molded part of the rotor hub 52.

A threaded shank 56 is accommodated in the through hole 54, the threaded shank 56 carrying an outer thread 58 along a part of its length which interacts with the inner thread of the rotor hub 52 and transforms the rotation of the rotor hub 52 into a translational motion of the threaded shank 56.

In addition, the rotor hub 52 has integrated bearing supports 60 which can accommodate roller bearings 62, in particular ball bearings, to support the rotor hub 52 in relation to the stator 44.

The stator 44 includes a stator core 64, being built up, for example, of a lamination stack, and phase windings 66. The phase windings 66 are connected to phase connectors 68.

The stator 44, together with the stator core 64, the phase windings 66 and the phase connectors 68, is fully embedded in an injection molded part 70 which directly forms the motor housing of the electric motor 40. In an alternative embodiment, this injection molded part 70 can be again enclosed by a separate motor casing, made preferably of metal. For the sake of simplicity, the injection molded part 70 will be depicted as a motor housing in the following description.

The motor housing 70 fully encloses the stator 44, so that the stator 44 is protected against environmental influences and, in particular, against liquids. A linear guide 72 and stops 73 to position and guide the threaded shank 56 are integrated into the motor housing 70. Moreover, the motor housing 70 has bearing supports 74 to accommodate the roller bearings 62. A motor flange 76 is directly molded onto the injection molded part of the motor housing 70, as is a plug/socket section 78 to receive the phase connectors 68 and to connect the electric motor to a power supply and/or an external control.

The roller bearings 62 are preloaded in the motor housing 70 using a spring wave washer 80 or a similar element.

In the illustrated embodiment, the electric motor of the invention acts as an actuator for a valve head 82 to operate, for example, the idle control valve of a carburetor of an internal combustion engine in a motor vehicle. A technician will realize that this is only one example of a large number of possible applications of the linear drive system presented in the invention. The threaded shank 56 takes on the function of an actuator rod and moves the valve head 82 when the rotor hub 52 rotates, depending on the direction of rotation—to the right or left in the drawing. To guide and support the valve head 82, a fastening element 84 and a spring 86, which is enclosed by a sleeve 88, are provided. These elements are meant specifically for the application of the electric motor of the invention as a linear actuator for the illustrated valve, in other applications of the motor of the invention, they can be replaced with other suitable positioning and fastening devices.

The characteristics revealed in the above description, the claims and the figures can be important for the realization of the invention in its various embodiments both individually and in any combination whatsoever.

### IDENTIFICATION REFERENCE LIST

10 First stator system

12 Second stator system

14 Rotor

16 Claw poles

18 Claw poles

20 Shaft

22 Rotor

24 South pole sprocket

26 North pole sprocket

28 Permanent magnet

30 Back iron yoke

32 Stator

34 Stator back yoke

36 Stator poles

38 Windings

40 Electric motor

42 Rotor

44 Stator

46 First pole plate

48 Second pole plate

50 Permanent magnet

52 Rotor hub

54 Through hole

56 Threaded shank

58 Outer thread

60 Rotor hub bearing supports

62 Roller bearing

64 Stator core

66 Phase windings

68 Phase connectors

70 Motor housing

72 Linear guide

73 Stop

74 Motor housing bearing supports

76 Motor flange

78 Plug/socket section

80 Spring wave washer

82 Valve head

84 Fastening element

86 Spring

88 Sleeve

1. An electric motor for a linear drive system comprising a motor housing within which a stator, a rotor and a threaded shank are accommodated,
the stator having a stator core and plurality of phase windings each connected to one of a plurality of phase connectors,
the rotor being mounted onto a rotor hub,
the rotor hub being supported in the motor housing by at least one roller bearing and coupled to the threaded shank to transform the rotation of the rotor into a translational motion of the threaded shank,
wherein
the motor housing includes an injection molded part within which the stator, together with the stator core and the phase windings, are embedded.

2. An electric motor according to claim 1, further comprising a stopper for positioning the threaded shank the stopper being integrated into the injection molded part of the motor housing.

3. An electric motor according to claim 2, wherein the phase connectors are embedded in the injection molded part of the motor housing.

4. An electric motor according to claim 1, wherein the threaded shank has an outer thread and the rotor hub has an inner thread which interact with each other.

5. An electric motor according to claim 4, wherein the rotor hub includes an injection molded part within which the rotor is embedded.

6. An electric motor according to claim 2, wherein bearing supports for the roller bearings are integrated into the injection molded part of the motor housing.

7. An electric motor for a linear drive system comprising a motor housing for receiving a stator, a rotor and a threaded shank,
the rotor being mounted on a rotor hub,
the rotor hub being supported in the motor housing by a plurality of roller bearings and coupled to the threaded shank via a thread to transform the rotation of the rotor into a translational motion of the threaded shaft,
wherein
the rotor hub includes an injection molded part within which the rotor is fixed, and the injection molded part of the rotor hub has an inner thread which interacts with an outer thread of the threaded shank.

8. An electric motor according to claim 7, wherein the rotor has two pole plates which are separated by a permanent magnet, the pole plates and the permanent magnet being held and positioned in the injection molded part of the rotor hub.

9. An electric motor according to claims 7, wherein a plurality of bearing supports for the roller bearings are integrated into the injection molded part of the rotor hub.

10. A linear actuator having an electric motor according to claim 1, wherein the electric motor is a hybrid stepping motor.

11. An electric motor according to claim 1, wherein the motor housing further comprises a linear guide to accommodate the injection molded part of motor housing.

12. An electric motor according to claim 1, wherein the stopper interacts with linear guide.

13. An electric motor according to claim 2, a motor flange is molded onto the injection molded part of the motor housing.

14. A linear actuator having an electric motor according to claim 7, wherein the electric motor is a hybrid stepping motor.
